(19) United States
(12) Patent Application Publication
(10) Pub. No.: US 2024/0238143 A1
(43) Pub. Date: Jul. 18, 2024

(54) Lateral Surgery System

(71) Applicant: NuVasive, Inc., San Diego, CA (US)

(72) Inventors: Bradley S. Anderson, San Diego, CA (US); Michael P. Jensen, San Diego, CA (US); Eric Finley, San Diego, CA (US)

(73) Assignee: NuVasive, Inc., San Diego, CA (US)

(21) Appl. No.: 18/559,207

(22) PCT Filed: Apr. 29, 2022
(86) PCT No.: PCT/US2022/027106

§ 371 Date: Nov. 6, 2023

(51) Int. Cl. A61G 13/12

(52) U.S. Cl. CPC A61G 13/1285

(57) ABSTRACT

The invention includes a device, system, and method for performing surgery on a patient. The invention includes an operating table having a cutout section which is configured to be repositioned, such as via partial or complete removal, to reveal a cutout opening which provides room for a part of a patient's anatomy to extend below the plane of the top surface of the table, in order to achieve desired positioning of other portions of the patient's anatomy.

### CROSS REFERENCE TO RELATED APPLICATION

The present patent application claims priority to U.S. Provisional Patent Application No. 63/184,926, filed on May 6, 2021, which is incorporated by reference as though fully set forth herein.

### FIELD OF THE INVENTION

The present invention relates to surgical systems, and more particularly, to methods and apparatuses for surgery on patients in a lateral position.

### BACKGROUND OF THE INVENTION

The human spine is comprised of a plurality of components (e.g. vertebral bodies, intervertebral discs, posterior bony structures) which collectively protect the spinal cord and enable the normal motions of flexion (bending forward), extension (bending backwards), lateral bending (bending side to side), and rotation (twisting). These normal physiologic motions may be impeded and/or painful when any number of conditions exist, including but not limited to disc degeneration, trauma, and deformity (e.g., scoliosis). Depending upon the condition, surgical intervention may be required to restore the normal physiologic function of the spine at the affected region.

When a patient is placed in a lateral position on a flat operating table, the spine may not be properly aligned for a desired surgical procedure. Various methods and apparatuses are known to attempt to address this issue, including bracings and other elements which attempt to reposition portions of the patient (e.g., the hips, shoulders, etc.) in order to properly align the spine for a procedure. For many patients, particularly patients having greater-than-average weight, when placed in the lateral position the patient's abdomen/belly can be held in a position that is too high, where the abdomen is held in a relatively higher position with respect to the rest of the patient. This upward positioning of the abdomen can cause the patient's spine to be distorted out of the alignment desired for the particular procedure.

Holding and maintaining the patient in a desired position may also be difficult, in that a patient in a lateral position may tend to roll forward or backward. Current solutions include using large wraps or tape to hold the patient in the desired position. Built-in systems which are a part of the table itself and are easy for a user to use may be desirable.

There is a need for lateral treatment systems and methods with improved and enhanced capabilities to maintain the patient in a proper lateral position, with the patient's spine aligned for desired treatment. The current invention fulfills this need.

### SUMMARY OF THE INVENTION

The present invention provides systems, devices, and methods for maintaining a patient in a lateral position during treatment procedures such as spinal surgeries.

In one embodiment, the invention uses a surgical table having a cutout opening adapted to accommodate a portion of the patient's abdomen, e.g., a portion of the belly. The cutout opening may be positioned at or adjacent a side of the surgical table. The surgical table may include a filler segment adapted to fill the cutout opening, with the filler segment adapted to lower or be lowered, or slide or be slid away from the table surface, or removed from the table entirely, in order to expose a portion of the cutout opening.

An operating table of the invention may have a table bed with a table top surface, head end, a foot end, a first side, and a second side, with the second side opposite the first side. A cutout opening may extend from the first side toward the second side, with the cutout opening having a cutout opening length and a cutout opening width. The cutout opening is shaped and sized and otherwise adapted to receive a belly of a patient, such as when the patient is in a lateral position on the table bed with the patient's belly extending over the cutout opening.

A cutout section with a cutout section top surface may be provided, which may be releasably positioned within the cutout opening such that the cutout opening is substantially filled by the cutout section, so that the cutout section top surface and the table top surface are in planar alignment to create a substantially continuous and planar surface. A table support, such as one or more table legs, may hold the table bed at a desired height above a floor. The table support may be adapted to permit the table bed to be selectively adjusted to different heights above the floor.

The cutout section may be adapted to be completely removed from the table bed, such as where the cutout section is removed and placed off to the side away from the table, such as, e.g., in a far corner of the operating room. Such complete removal may involve sliding and/or lifting the cutout section away from and off of the table bed. The cutout section may be adapted to remain secured to the table bed, but to be repositioned to different positions with respect to the table bed. For example, the cutout section may be adapted to be slidingly positioned within the cutout opening, with the cutout section adapted to slide or be slid with respect to the table such that the cutout section slides under or into the table bed in order to reveal all or a portion of the cutout opening. Such sliding may be lengthwise and/or sideways with respect to the table bed.

The cutout section may be adapted to remain with the table, but to be repositioned with respect to the table top surface. For example, an adjustable support element may secure the cutout section to the table, with the adjustable support element being adapted to permit the cutout section to be repositioned away from the cutout opening. The adjustable support element may be adapted to permit the cutout section to be lowered away from the cutout opening. The adjustable support element may adapted to permit the cutout section to be repositioned and secured at a position where the cutout section top surface is at a range of depths below the table top surface. The adjustable support element may be a hinge adapted to permit the cutout section to be rotated with respect to the table bed.

The invention includes methods of operating on a patient. Such a method may include providing an operating table such as those disclosed above and elsewhere in this application, and such method may include any combination of one or more or all of the following: positioning the patient on the table bed in a lateral position; moving the cutout section to reveal at least a substantial portion of the cutout opening; positioning a belly portion of the patient in the cutout opening; confirming proper positioning of the patient for a desired procedure on the patient; and performing the desired procedure on the patient. Prior to positioning the patient in a lateral position on the table bed, the method may include placing the patient on the table bed in a non-lateral position. Moving the cutout section to reveal at least a substantial portion of the cutout opening may be performed after positioning the patient into a lateral position on the table bed. Adjusting the distance between the table top surface and the cutout section top surface may be performed responsively to the positioning of the patient on the table bed in order to achieve proper positioning of the patient for the desired procedure on the patient. Such methods may be methods for treating a spine of the patient, and confirming proper positioning of the patient for a desired procedure on the patient may involve confirming proper spinal alignment of the patient. The cutout section may be adapted to be selectively repositioned in various selected positions with respect to the table bed, and the method may further involve repositioning the cutout section with respect to the table bed responsive to the positioning of the patient on the table bed in order to achieve proper positioning of the patient for the desired procedure on the patient.

The cutout section may comprise a cutout section top surface, and the cutout section may be adapted to be selectively lowered relative to or with respect to the table top surface. With such aspects of the cutout section, the method may involve adjusting the distance between the table top surface and the cutout section top surface, which may be performed responsive to the positioning of the patient on the table bed in order to achieve proper positioning of the patient for the desired procedure on the patient.

The invention may include systems for performing surgery on a patient, including, e.g., surgeries in which the patient is positioned in a lateral position. Such a system may include an operating table such as those disclosed above and elsewhere in this application, and such a system may include any combination of one, more than one, or all of the following: an imaging system for providing real-time display of one or more portions of the patient's anatomy; and a monitoring system for monitoring one or more patient functions. The imaging system may include an x-ray system, such as an x-ray fluoroscopy system. Such a system may include a C-arm element. The operating table may be adapted, such as, e.g., by having one end free and unobstructed (such as where a support leg is at the opposing table end and the table free end is cantilevered away from the support leg), to receive the C-arm element around the free table end so that the C-arm element can be moved over and along a substantial length of the table without obstruction in order to image one or more portions of the patient's anatomy as the patient is on the table. One or more portions of the table may be substantially transparent/translucent to the imaging system, such as by being radiolucent, in order to improve imaging from the imaging system.

Other objects, features, and advantages of the present invention will become apparent from a consideration of the following detailed description.

### BRIEF DESCRIPTION OF THE DRAWINGS

FIG. 1 is a top view of a system for treating a patient in a lateral position;

FIGS. 2A, 2B, and 2C depict top, side, and end views, respectively, of an operating table according to an embodiment of the invention;

FIG. 2D depicts a top view of the operating table of FIGS. 2A-2C with the cutout opening exposed;

FIGS. 3A and 3B depict top and cross sectional end views, respectively, of the operating table of FIGS. 2A-2C with a patient disposed thereon;

FIGS. 4A and 4B depict top and cross sectional end views, respectively, of the operating table of FIGS. 2A-2C with a patient disposed thereon;

FIGS. 5A, 5B, and 5C depict top, side, and cross sectional end views, respectively, of an operating table according to an embodiment of the invention;

FIGS. 6A, 6B, and 6C depict top, side, and cross sectional end views, respectively, of an operating table according to an embodiment of the invention;

FIGS. 7A and 7B depict top and side views of an operating table according to an embodiment of the invention;

FIGS. 8A-8D depict top views of variations of an operating table according to embodiments of the invention;

FIGS. 9A and 9B depict top and side views, respectively, of an operating table according to an embodiment of the invention;

FIG. 9C depicts a side view of the operating table of FIGS. 9A-9B in a bent position according to an embodiment of the invention; and

FIGS. 10A and 10B depict top and side views, respectively, of an operating table according to an embodiment of the invention.

### DETAILED DESCRIPTION OF SEVERAL EMBODIMENTS

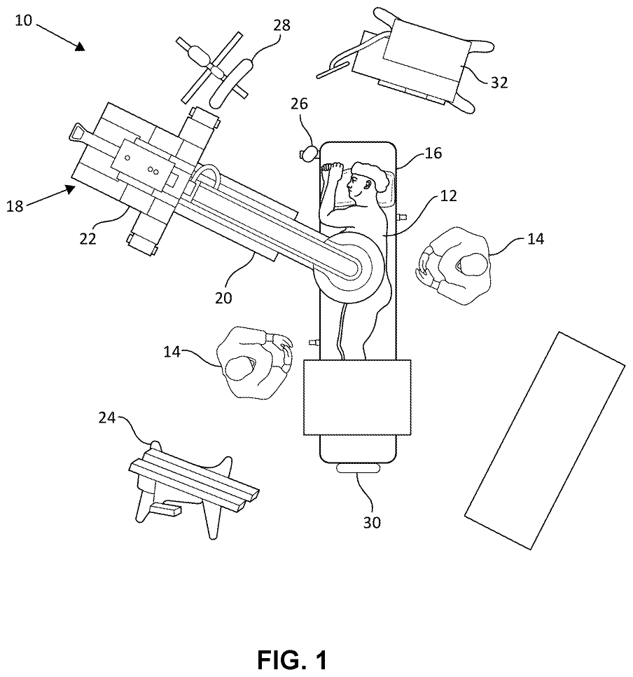

A system 10 for treating of a patient 12 in a lateral position is depicted in FIG. 1. Medical personnel 14, such as surgeons and nurses, are also depicted. The system 10 includes an operating table 16 on which the patient 12 is situated in a lateral position. An imaging system 18 such as an x-ray fluoroscopy system may include a C-arm element 20 positioned and adapted to extend over the table 16, with the C-arm element 20 including appropriate imaging elements such as x-ray source and/or receptor. The imaging system 18 includes an image processor 22 which may be configured to process signals received from the C-arm element to create images of patient anatomy. Imaging system 18 may further include monitors or displays 24 configured to display the images for viewing by the medical personnel 14. Additional imaging systems may also be included, such as a camera 26 configured to provide images to a table-side image array 28. Monitoring systems may include a neuromonitoring system 30 and cardiac monitoring system 32.

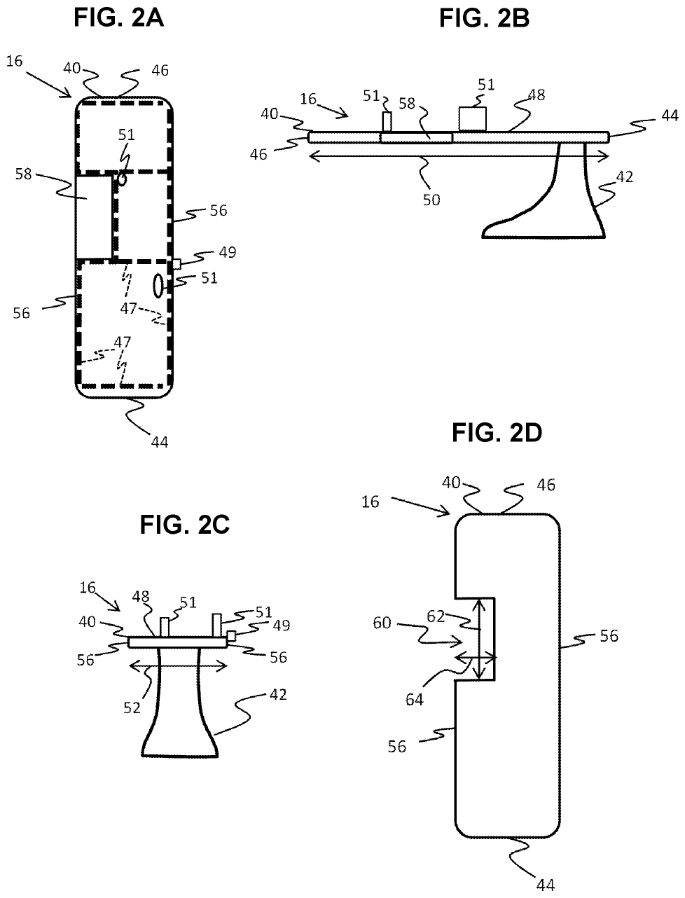

Further details of a table 16 according to an embodiment of the invention are depicted in FIGS. 2A-2D. The table 16 may comprise a table bed 40 sized and configured to receive a patient thereon in a lateral position. In the particular embodiment depicted, the table bed 40 is supported by a single pedestal 42 which may preferably be adjacent one end, e.g., such as the foot end 44, or head end 46 of the table 16. This positioning of the pedestal 42 permits the C-arm or other imaging/monitoring equipment to extend around the table bed 40 around the patient's spinal areas during treatment procedures. Alternatively, the table bed 40 may be supported by supports positioned at both ends 44, 46 of the table bed 40. In certain embodiments, the table bed 40 may preferably be translucent to desired imaging systems, such as by being radiolucent.

The table bed 40 may include a support frame 47 (FIG. 2A), which may be formed of carbon fiber and/or may be substantially radiolucent. The support frame 47 may be adapted to receive one or more attachments 49 thereon. One or more patient supports 51 may be provided, which can assist in holding a patient in a desired position, such as a lateral position. Patient supports 51 may be configured to prevent the patient from rolling backward, i.e. toward a supine position, or forward, i.e. toward a prone position. Such supports may include rod or plate supports, and may be adapted to be moved and repositioned on the table in order to accommodate patients of different sizes.

The top 48 of the table bed 40 may preferably be sufficiently padded while still providing appropriate firmness to prevent excess patient movement. The table bed 40 may have an overall length 50 from the foot end 44 to the head end 46, and an overall width 52 between sides 56. In some embodiments, the overall table 40 width 52 may be somewhat narrower, such as by 3 inches or more, than is the case for traditional operating tables for spinal procedures, in order to permit surgeons or other medical personnel 14 (FIG. 1) to position themselves closer to the patient 12. For example, a traditional operating table may have a width of about 20 inches (about 50.8 cm), while an operating table bed 40 according the present disclosure may have a width of about 14 inches (about 35.6 cm), 15 inches (about 38.1 cm), 16 inches (about 40.6 cm), 17 inches (about 43.2 cm), 18 inches (about 45.7 cm), or 19 inches (about 48.3 cm).

One or both of sides 56 of the table bed 40 may have a removable cutout section 58 (FIGS. 2A-2B), which when removed or otherwise displaced from its original position leaves a cutout opening 60, as depicted in FIG. 2D. The cutout opening 60 may preferably be configured in size, shape, and position to accommodate the abdomen, aka belly, of a patient when the patient is in the lateral position, while preventing other portions of the patient's body from entering the cutout opening 60, such as the patient's chest, shoulder, hip, and back. The cutout section may also permit a surgeon or other medical personnel to position themselves closer to the patient without engaging the table edge.

As shown in the embodiment of FIGS. 2A-2D, the cutout opening 60 may be substantially rectangular, and may have a length 62 and a width 64. Other shapes of cutout openings are also within the scope of the invention, such as, e.g., curved shapes. The support frame 47 may be configured as depicted in FIG. 2A to pass around the inner perimeter of the cutout opening 60, such that the cutout opening 60 is entirely open on one side 56 of the table bed 40.

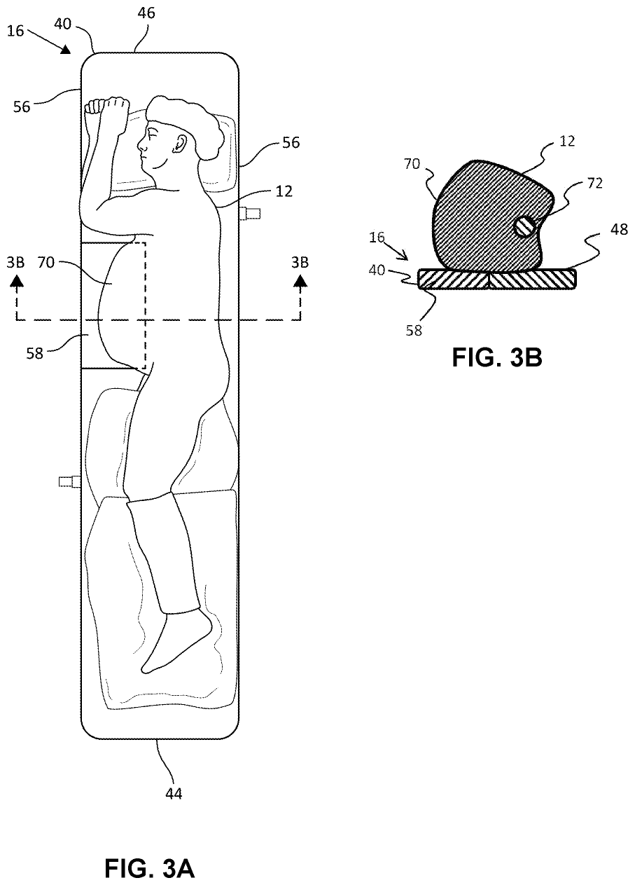

FIGS. 3A-3B depict a patient 12 in a lateral position on a table 16 with the cutout section 58 in place and level with the rest of the table top surface 48, so that the patient's abdomen 70 is held up. In a standard treatment table, such positioning of the patient's abdomen 70 may make it difficult to properly position the patient in a lateral position for treatment because the patient's abdomen may tend to twist or rotate the patient's body, which may cause the patient's spine 72 (FIG. 3B) to assume a curved and/or twisted position.

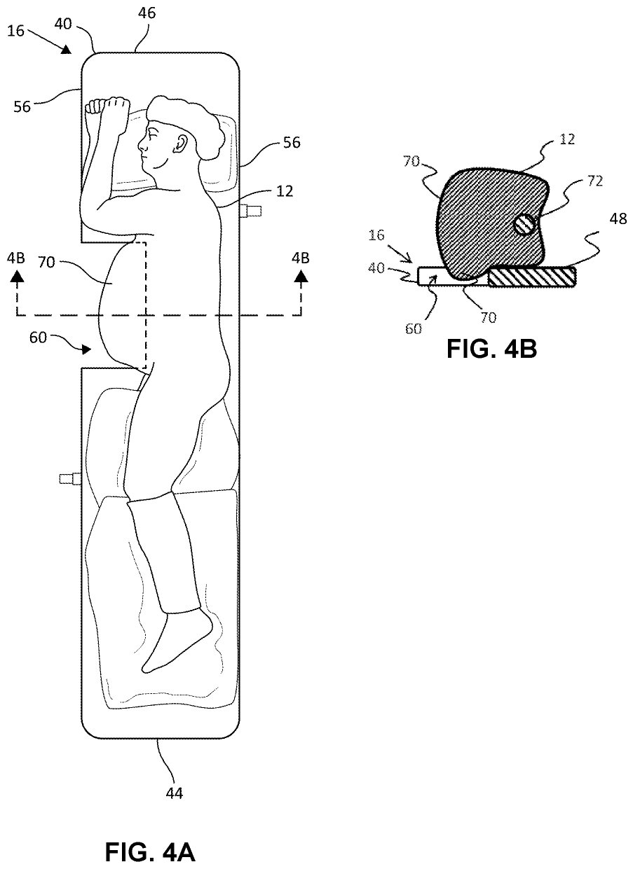

FIGS. 4A-4B depict a patient 12 in a lateral position on a table 16 with the cutout section 58 (FIG. 3A) removed to reveal the cutout opening 60, with a portion of the patient's abdomen 70 extending downward into the cutout opening 60, below the plane of table top surface 48. The resulting downward displacement of the portion of the patient's abdomen 70 enables the patient's spine 72 to be properly aligned for surgical or other treatments.

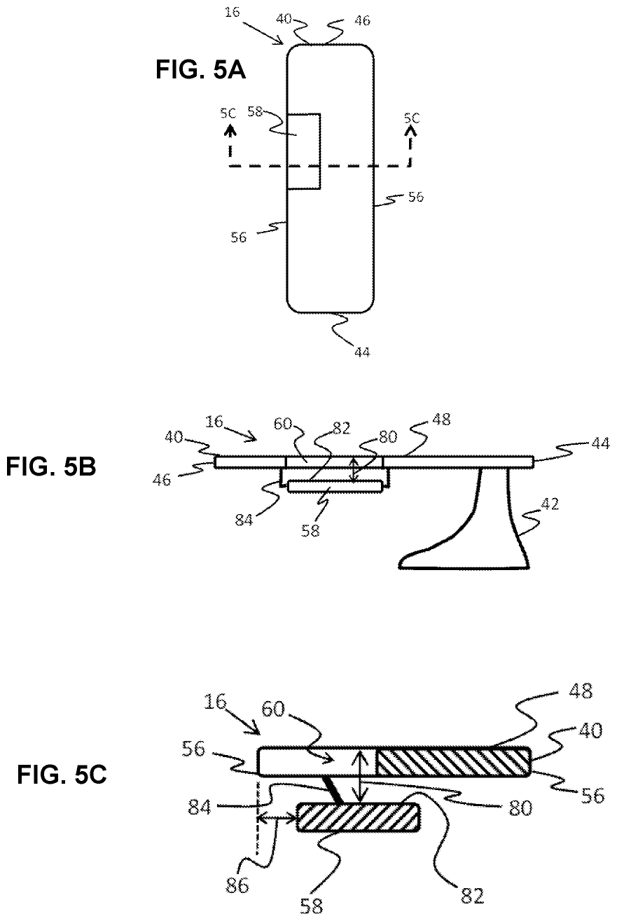

FIGS. 5A-5C depict an operating table 16 according to an embodiment of the invention, in which the cutout section 58 is adapted to lower away from the plane of table top surface 48, such as via extendable supports 84, to create a cutout opening 60 having a depth defined by the distance 80 by which the cutout section 58 is displaced below the table top surface 48. Extendable supports 84 may extend and retract via, e.g., telescopic motion or other similar motion. Such a table 16 may be configured so that the cutout section 58 may be selectively lowered to variable distances 80, so that the depth of the cutout opening 60 can be selectively adjusted to accommodate patients with of different sizes/characteristics, e.g., with different sizes of abdomens. For example, for a patient with a larger abdomen, the cutout section 58 may be lowered a distance 80 which is relatively large, while for a patient with a smaller abdomen the cutout section 58 may be lowered by a distance 80 which is relatively small. In a lowered position, the upper surface 82 of the cutout section 58 may provide some support to the patient's abdomen, which still permitting a portion of the abdomen to drop with respect to the table top surface 48 in order to maintain the patient's spine in a desired alignment for surgery or other treatment. The cutout section 58 may also be adapted to be displaced sideways a distance 86 from the table side 56. In the particular embodiment of FIG. 5C, the cutout section 58 is displaced laterally from the table side 56. In particular, cutout section 58 is displaced in a direction toward a longitudinal midline of table bed 40, and also toward the opposing table side 56. In this manner, cutout section 58 may be considered to slide further under table bed 40. In other embodiments however, the sideways displacement could alternatively be in the opposite direction, i.e., outward from the table bed 40, and away from a midline of table bed 40. In either case, extendable supports 84 may extend at an angle, creating an acute angle between a lower surface of table bed 40 and extendable support 84, and an obtuse angle between extendable support 84 and upper surface 82 of cutout section 58.

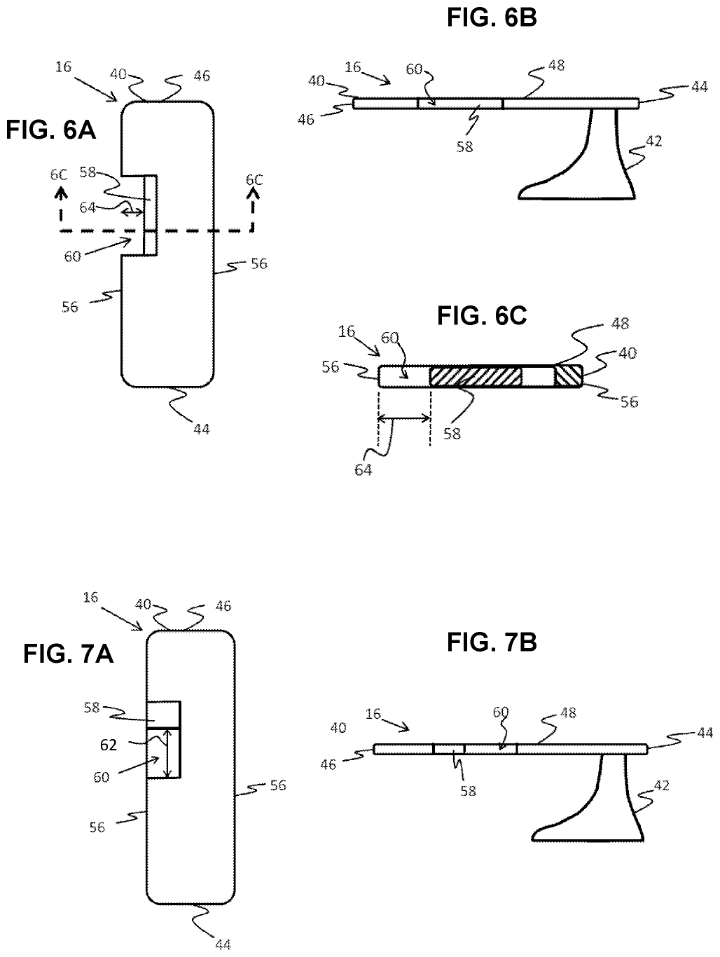

In another embodiment of a cutout section 58 depicted in FIGS. 6A-6C, the cutout section 58 is adapted to slide into or directly under the table bed 40, such as by sliding sideways toward a longitudinal midline of table bed 40. Such sliding retraction of the cutout section 58 may be configured to permit the cutout opening 60 to be selectively varied in size, e.g., varied in width 64, in order to accommodate patients with different physical sizes and shapes. As depicted in FIGS. 7A-7B, the cutout section 58 may be adapted to slide lengthwise into or under the table bed 40, such that the length 62 of the cutout opening 60 can be varied, which can be used to accommodate patients having different torso/belly lengths. In the particular embodiment of FIGS. 7A-7B, the cutout section 58 is adapted to slide in the direction toward the head end 46 of the table bed 40—although other sliding directions are also within the scope of the invention.

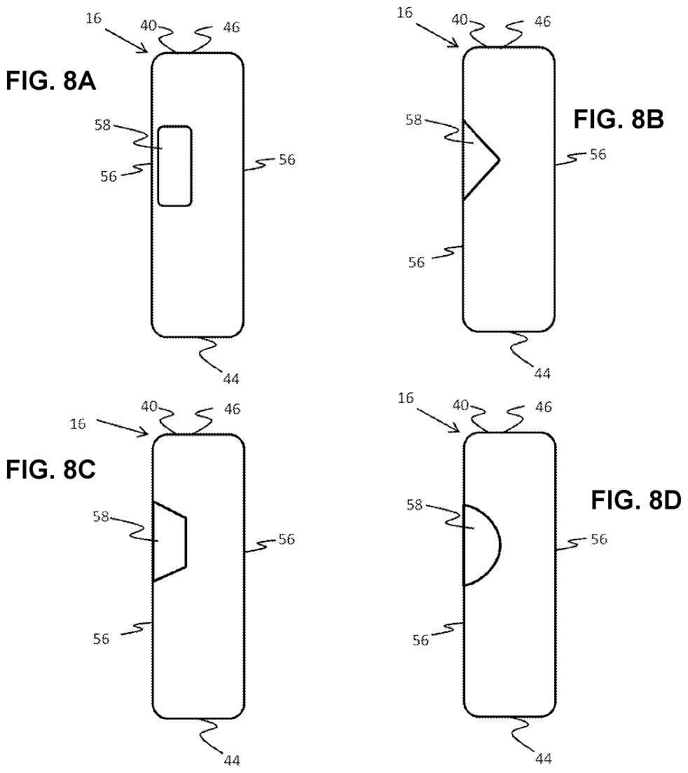

Cutout sections may be in various configurations. For example, in the embodiment of FIG. 8A, the cutout section 58 is positioned toward one side 56 of the table 16, but the cutout section 58 does not extend all the way to the side 56. Instead, cutout section 58 stops short of the side 56. In such an embodiment, a support frame 47 (not shown in FIG. 8A) may extend around a periphery of table bed 40, and cutout section 58 may be disposed within support frame 47.

Various shapes of cutouts are also within the scope of the invention. For example, in the embodiment of FIG. 8B, the cutout section 58 is generally triangular in shape. In the embodiment of FIG. 8C, the cutout section 58 is generally trapezoidal in shape. In the embodiment of FIG. 8D, the cutout section 58 is generally curved in shape. Various other shapes are also considered to be within the scope of the invention. The cutout sections 58 and corresponding cutout openings 60 of the invention may preferably be adapted in size and shape and other configurations to permit the patient's abdomen or belly to drop below the plane of table top surface 48 as shown in, e.g., FIG. 4B, but still provide for proper support by the table top surface 48 for the patient's shoulders, hips, and back.

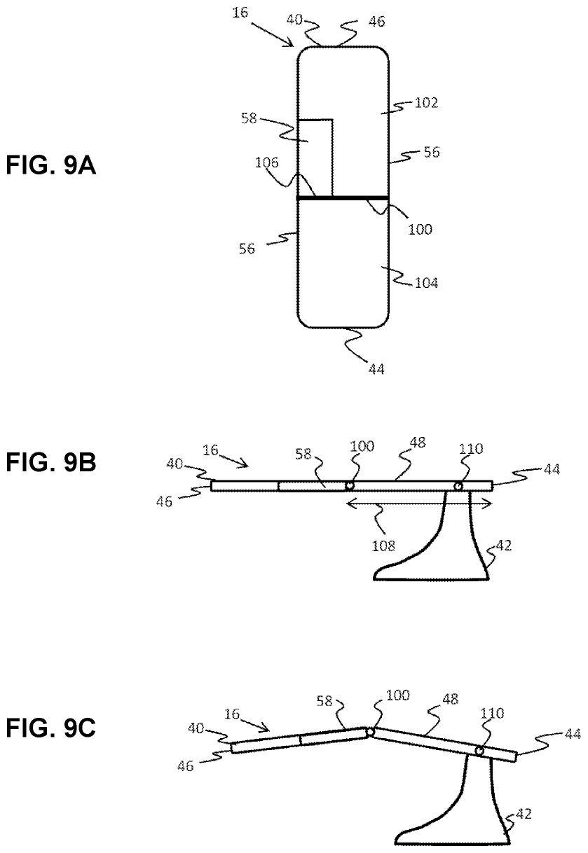

Tables according to the present invention, such as depicted in FIGS. 9A-9B, may further include a hinge 100 in the table bed 40, about which the upper portion 102 and lower portion 104 of the table bed may rotate with respect to each other. The hinge 100 may be located at a position along the table bed 40 a distance 108 from either end of the table bed 40, e.g., adjacent the lower end 106 of the cutout section 58. In various embodiments, distance 108 may be, e.g., approximately half of the length 50 (FIG. 2B) of table bed 40, from the foot end 44 to the head end 46. In other embodiments, distance 108 may be, e.g., about one third, about two thirds, about one quarter, or about three quarters of the length 50 (FIG. 2B) of table bed 40, from the foot end 44 to the head end 46.

FIG. 9C depicts a side view of the operating table of FIGS. 9A-9B in a bent or angled position. As shown in FIG. 9C, the upper portion 102 is rotated with respect to the lower portion 104 about the hinge 100. A second hinge 110 is positioned to permit the lower portion 104 to rotate with respect to the table support or pedestal 42. The angled position may be useful to properly align a patient, to create tension in skin, and/or to separate rib(s) from endplate(s), etc.

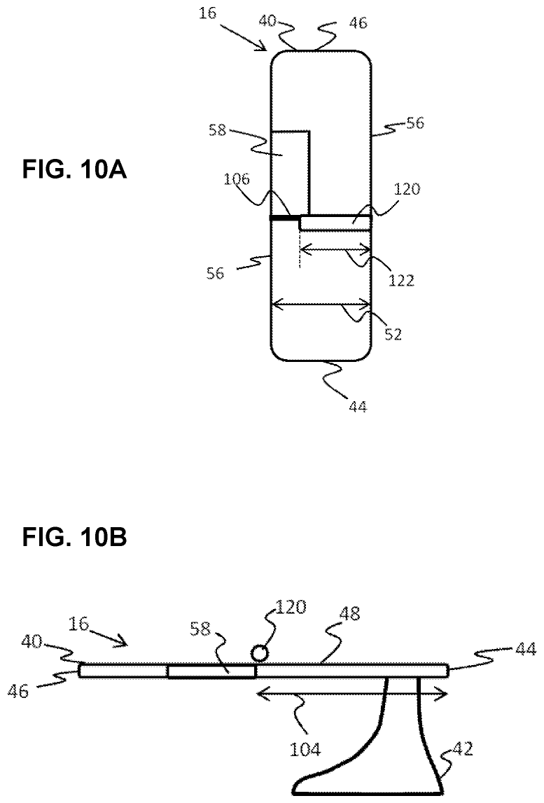

Tables according to the invention may include other elements to assist in proper patient positioning. For example, as depicted in FIGS. 10A-10B, one or more bolsters 120 may be included to support the patient's anatomy. Such bolsters may configured to assist with one or more of: properly aligning the patient, creating tension in skin, or separate rib(s) from endplate(s), etc. In the example depicted in FIGS. 10A-10B, a bolster 120 is positioned adjacent the lower edge 106 of the cutout section 58. The bolster 120 has a length 122 which may extend entirely or partially across the width 52 of the table bed 40. The bolster 120 may be used in combination with hinges such as those depicted in FIGS. 9A-9C.

Although disclosed separately, each element of each embodiment and its respective elements disclosed herein can be used with any other embodiment and its respective elements disclosed herein. For example, the cutout section 58 shapes of FIGS. 8A-8D are independently combinable with features of, e.g., the embodiments of FIGS. 5A-5C, 6A-6C, 7A-7B, 9A-9C, and/or 10A-10B. Other combinations and sub-combinations are equally possible and are omitted for purposes of brevity only.

All dimensions listed are by way of example, and devices according to the invention may have dimensions outside those specific values and ranges. The dimensions and shape of the device and its elements depend on the particular application. Unless otherwise noted, all technical and scientific terms used herein have the same meaning as commonly understood by one of ordinary skill in the art to which this disclosure belongs. In order to facilitate review of the various embodiments of the disclosure, the following explanation of terms is provided:

As used herein, the singular terms “a”, “an”, and “the” include plural referents unless context clearly indicates otherwise. The term “or” refers to a single element of stated alternative elements or a combination of two or more elements, unless context clearly indicates otherwise. The term “includes” means “comprises.” For example, a device that includes or comprises A and B contains A and B, but may optionally contain C or other components other than A and B. Moreover, a device that includes or comprises A or B may contain A or B or A and B, and optionally one or more other components, such as C. As further used herein, the term “subject” refers to both human and other animal subjects. In certain embodiments, the subject is a human or other mammal, such as a primate, cat, dog, cow, horse, rodent, sheep, goat, or pig. In a particular example, the subject is a human patient.

Although methods and materials similar or equivalent to those described herein can be used in the practice or testing of the present disclosure, suitable methods and materials are described below. In case of conflict, the present specification, including terms, will control. In addition, the materials, methods, and examples are illustrative only and not intended to be limiting.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

What is claimed is:

1. An operating table, comprising:
a table bed comprising a table top surface, a head end, a foot end, a first side, and a second side, wherein the second side is opposite the first side;
a cutout opening extending from the first side toward the second side, the cutout opening comprising a cutout opening length parallel to the first side and a cutout opening width perpendicular to the first side, wherein the cutout opening is adapted to receive a belly of a patient; a cutout section comprising a cutout section top surface, wherein the cutout section is configured to provide a complementary and releasable fit with the cutout opening, wherein when the cutout section is disposed within the cutout opening, the cutout section top surface is in planar alignment with the table top surface; and
a table support adapted to hold the table bed at a desired height above a floor.

2. The operating table of claim 1, wherein the cutout section is slidingly positioned within the cutout opening, with the cutout section adapted to slide with respect to the table such that the cutout section slides out of the cutout opening.

3. The operating table of claim 2, wherein the cutout section is adapted to slide lengthwise with respect to the table bed.

4. The operating table of claim 2, wherein the cutout section is adapted to slide sideways with respect to the table bed.

5. The operating table of claim 1, wherein the cutout section is adapted to be removed from the table bed.

6. The operating table of claim 5, wherein the cutout section is adapted to be removed from the table bed via sliding movement in a laterally outward direction from the first side of the table bed.

7. The operating table of claim 5, wherein the cutout section is adapted to be removed from the table bed via upward lifting from the table bed.

8. The operating table of claim 1, further comprising an adjustable support element configured to secure the cutout section to the table bed, wherein the adjustable support element is adapted to permit the cutout section to be repositioned away from the cutout opening.

9. The operating table of claim 8, wherein the adjustable support element is adapted to permit the cutout section to be lowered away from the cutout opening.

10. The operating table of claim 8, wherein the adjustable support element is adapted to permit the cutout section to be repositioned and secured at a position in which the cutout section top surface is disposed below the table top surface.

11. The operating table of claim 8, wherein the adjustable support element is a hinge adapted to permit the cutout section to be rotated with respect to the table bed.

12. The operating table of claim 1, wherein the table bed comprises a radiolucent frame.

13. A system for performing surgery on a patient in a lateral position, comprising:
an operating table comprising:
a table bed comprising a table top surface, a head end, a foot end, a first side, and a second side, wherein the second side is opposite the first side;
a cutout opening extending from the first side toward the second side, the cutout opening comprising a cutout opening length parallel to the first side and a cutout opening width perpendicular to the first side, wherein the cutout opening is adapted to receive a belly of a patient;
a cutout section comprising a cutout section top surface, wherein the cutout section is configured to provide a complementary and releasable fit with the cutout opening, wherein when the cutout section is disposed within the cutout opening, the cutout section top surface is in planar alignment with the table top surface, and wherein the cutout section is adapted to move out of the cutout opening; and
a table support adapted to hold the table bed at a desired height above a floor;
an imaging system for providing real-time display of one or more portions of the patient's anatomy; and
a monitoring system for monitoring one or more patient functions.

14. The system of claim 13, wherein the imaging system comprises an x-ray fluoroscopy system comprising a C-arm element, wherein the table bed is adapted to receive the C-arm element around a portion thereof in order to image the one or more portions of the patient's anatomy.

15. The system of claim 13, wherein the table bed is substantially radiolucent.

16. The system of claim 13, wherein the table bed at the head end is free and unobstructed such that the C-arm may be passed around and over the table bed starting at the head end and continuing for at least half an overall length of the table bed.

17. A method of operating on a patient, comprising:
providing an operating table comprising:
a table bed comprising a table top surface, a head end, a foot end, a first side, and a second side, wherein the second side is opposite the first side;
a cutout opening extending from the first side toward the second side, the cutout opening comprising a cutout opening length parallel to the first side and a cutout opening width perpendicular to the first side, wherein the cutout opening is adapted to receive a belly of a patient;
a cutout section comprising a cutout section top surface, wherein the cutout section is configured to provide a complementary and releasable fit with the cutout opening, wherein when the cutout section is disposed within the cutout opening, the cutout section top surface is in planar alignment with the table top surface; and
a table support adapted to hold the table bed at a desired height above a floor;
positioning the patient on the table bed in a lateral position;
moving the cutout section at least partially out of the cutout opening;
positioning a belly portion of the patient at least partly within the cutout opening and extending below the table top surface;
confirming proper positioning of the patient for a desired procedure on the patient; and
performing the desired procedure on the patient.

18. The method of claim 17, further comprising:
prior to positioning the patient in a lateral position on the table bed, placing the patient on the table bed in a non-lateral position.

19. The method of claim 17, wherein moving the cutout section at least partially out of the cutout opening is performed after positioning the patient into a lateral position on the table bed.

20. The method of claim 17, wherein performing the desired procedure includes treating a spine of the patient, and confirming proper positioning of the patient for the desired procedure on the patient comprises confirming proper spinal alignment of the patient.

21. The method of claim 17, wherein the cutout section is adapted to be selectively repositioned in various selected positions with respect to the table bed, the method further comprising:
repositioning the cutout section with respect to the table bed in response to the positioning of the patient on the table bed in order to achieve proper positioning of the patient for the desired procedure on the patient.

22. The method of claim 17, wherein the cutout section comprises a cutout section top surface, and the cutout section is adapted to be selectively lowered with respect to the table top surface so as to change a distance between the table top surface and the cutout section top surface, the method further comprising:
adjusting the distance between the table top surface and the cutout section top surface.

23. The method of claim 22, wherein adjusting the distance between the table top surface and the cutout section top surface is performed in response to the positioning of the patient on the table bed in order to achieve proper positioning of the patient for the desired procedure on the patient.
